(19) United States
(12) Patent Application Publication
(10) Pub. No.: US 2015/0246770 A1
(43) Pub. Date: Sep. 3, 2015

(54) LARGE SCALE SUBSEA STORAGE TANK AND METHOD FOR CONSTRUCTING AND INSTALLING THE SAME

(71) Applicant: KOREA ADVANCED INSTITUTE OF SCIENCE AND TECHNOLOGY, Daejeon (KR)

(72) Inventors: Dae Jun Chang, Daejeon (KR); Pal G. Bergan, Daejeon (KR)

(73) Assignee: KOREA ADVANCED INSTITUTE OF SCIENCE AND TECHNOLOGY, Daejeon (KR)

(21) Appl. No.: 14/436,797

(22) PCT Filed: Oct. 18, 2012
(86) PCT No.: PCT/KR2012/008542

§ 371 Date: Apr. 17, 2015

(51) Int. Cl. B65D 88/78; F17C 1/00; B65D 90/00

(52) U.S. Cl. CPC B65D 88/78; B65D 90/0066; F17C 1/007; F17C 2203/0612

(57) ABSTRACT

Provided are a subsea storage tank for fluids and a method for building and installing the same. An exemplary embodiment of the present invention provides a subsea storage tank, including: a body having a storage space therein and formed of light weight concrete inner and outer sides of which are watertight coated or plated; a ballast placed on the body of the subsea tank; and a separation unit disposed inside the body and partitioning the storage space upper and lower, the separation unit being movable vertically in the storage space in accordance with the degree of storage fluid filling.

### TECHNICAL FIELD

The present invention relates to a subsea storage tank and a method for building and installing the same, and in particular, to a subsea storage tank which can be very large and can be used for underwater storage on the sea floor by using light weight concrete, and a method for building and installing the same.

### BACKGROUND ART

Oil or gas produced from offshore hydrocarbon wells that are not connected by pipelines are normally temporarily stored in floating installations and transported by shuttle tankers to be processed further onshore. In recent years, the locations where offshore oil wells are developed have gradually moved from shallow waters to the deep sea, and enabling technologies for developing deep sea hydrocarbon wells are much in demand. In this context, subsea storage tanks for deep sea storage of oils or gases produced from deep sea wells can enable and greatly improve production and transportation of hydrocarbon resources from deep sea fields.

However, designing and installing large subsea tanks for oil and gas is by no means an easy task. First of all, the tank has to be light enough to be transportable and not weigh too much during the installation phase which will have to be supported by surface platforms or crane ships. Second, the tank has to be heavy enough not to float up again when filled with hydrocarbons which typically are much lighter than seawater. Air filling of the tank may be used to increase buoyancy during the installation phase; unfortunately, air volume will be greatly reduced with increasing water pressure, and density differences between air and water give rise to severe stress in the tank walls. These problems become even more severe for very deep water situations, such as for 500 to 3000 m water depth for which gravity platforms with storage and fixed installation represent no alternative. But even for fields at less water depth use of subsea tanks may represent a great benefit at the same time as being a severe technical challenge. Accordingly, a new type of subsea storage tank which can be constructed on a land so as to be easily manufactured, can have large storage volume, and can used in a deep sea environment will provide a much sought for benefit for the offshore oil and gas industry.

There may be other applications as well for the current invention. One such may be for temporary storage of carbon dioxide (CO2) in tanks on the sea floor. Such application may arise in connection with future development of the carbon capture and storage (CCS) chain for which large amounts of CO2 may be transported onboard ships in cooled and pressurized condition. Intermediary deep water subsea storage tanks of the present type may facilitate fast unloading of the cargo from the ship before the CO2 gradually is injected by subsea installations into suitable geological rock formations below.

Another example may be to store liquefied petroleum gas (LPG) or natural gas liquid (NGL), which currently is normally stored in underground cavities sealed by surrounding water. As an alternative, LPG or NGL may be injected into subsea storage tanks of the present type at a depth where they will be kept in liquid state at sea temperature due to the pressure from the surrounding water.

### DISCLOSURE OF INVENTION

### Technical Problem

The present invention represents an effort to provide a subsea storage tank which can be designed with large size, used in a deep sea environment, and can be easily constructed on land, transported in a floating state and stably placed on deep seabed, and a method for operating the same.

### Solution to Problem

In accordance with an aspect of the present invention, there is provided a subsea storage tank, comprising: a body having a storage space therein and constructed by use of light weight concrete for which the inner and outer sides are coated or covered by watertight material; a ballast disposed at the body after installation; and a separation unit disposed inside the main body of the tank partitioning the storage space upward and downward, the separation unit being movable vertically in the storage space.

In accordance with another aspect of the present invention, the separation unit is removed so that the storage tank should play the role of both the storage system and the gravitation separator to separate the well fluid in gas, oil, produced water and mud phase.

In accordance with another aspect of the present invention, there is provided a method for installing a subsea storage tank, comprising: a construction step of building a subsea storage tank; a launching step of floating the subsea storage tank onto the sea; a towing step of moving the subsea storage tank to a desired installation location; a ballast step of letting seawater into the subsea storage tank to submerge the subsea storage tank; a step of controlled lowering of the subsea storage tank to settle the subsea storage tank on the sea floor; and a ballasting and/or an anchoring step to provide fixing the subsea storage tank on the sea floor and to prevent it from floating when filled with hydrocarbons.

### Advantageous Effects of Invention

In the subsea storage tank and the method for installing the subsea storage tank according to the exemplary embodiments of the present invention, the subsea storage tank can be of very large size and can be easily constructed and installed by using light weight concrete.

In the subsea storage tank and the method for installing the subsea storage tank according to the exemplary embodiments of the present invention, the subsea storage tank can be completely built on land or in a dry dock, and can be moved to a desired installation location to be installed. Accordingly, in the subsea storage tank and the method for installing the subsea storage tank according to the exemplary embodiments of the present invention, the subsea storage tank can be manufactured and easily installed.

Moreover, in the subsea storage tank and the method for installing the subsea storage tank according to the exemplary embodiments of the present invention, the subsea storage tank can be installed and used in a state in which air is not present in the subsea storage tank, and thus can be installed and used in a deep sea environment. Notably, avoidance of using compressed air for buoyancy during installation is also an important safety issue.

In addition, in the subsea storage tank and the method for installing the subsea storage tank according to exemplary embodiments of the present invention, the subsea storage tank includes a separation unit therein, and thus can naturally prevent seawater and hydrocarbon from being mixed.

In addition, in the subsea storage tank and the method for installing the subsea storage tank according to exemplary embodiments of the present invention, the subsea storage tank excludes a separation unit therein, and thus can play the role of both the storage system and the gravitation separator to separate the well fluid in gas, oil, produced water and mud phase.

### BRIEF DESCRIPTION OF DRAWINGS

FIG. 1 is a side sectional view schematically illustrating a subsea storage tank according to an exemplary embodiment of the present invention.

FIG. 2 is a side sectional view schematically illustrating a pipe system according to an exemplary embodiment of the present invention where the incoming fluid is mainly a liquid phase in FIG. 2(a) and a multi-phase in FIG. 2(b).

FIG. 3 is a sectional view taken long line II-II of FIG. 1.

FIG. 4 is a sectional view illustrating a variant example of the subsea storage tank of FIG. 1.

FIG. 5 is an enlarged view illustrating portion A of FIG. 2.

FIG. 6 is an enlarged view illustrating portion B of FIG. 2.

FIG. 7 is an operational view illustrating a method for construction of a subsea storage tank in a dock according to an exemplary embodiment of the present invention.

FIG. 8 is an operational view illustrating a launching method for a subsea storage tank according to the exemplary embodiment of the present invention.

FIG. 9 is an operational view of towing the tank to the intended location as part of the method for installing a subsea storage tank according to the exemplary embodiment of the present invention.

FIG. 10 is an operational view illustrating a ballast step of the method for installing a subsea storage tank according to the exemplary embodiment of the present invention.

FIG. 11 is an operational view illustrating a seafloor placing step of the method for installing a subsea storage tank according to the exemplary embodiment of the present invention.

FIG. 12 is an operational view of an anchoring step of the method for installing a subsea storage tank according to the exemplary embodiment of the present invention.

FIG. 13 is a first view of storage operation of hydrocarbons within a subsea storage tank according to the exemplary embodiment of the present invention.

FIG. 14 is a second view of storage operation of hydrocarbons within a subsea storage tank according to the exemplary embodiment of the present invention.

### MODE FOR THE INVENTION

Hereinafter, a subsea storage tank according to an exemplary embodiment of the present invention will be described with reference to the accompanying drawings.

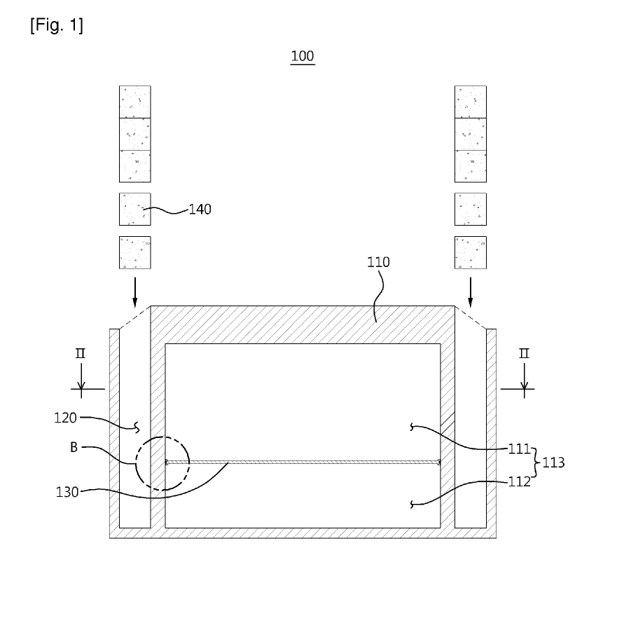

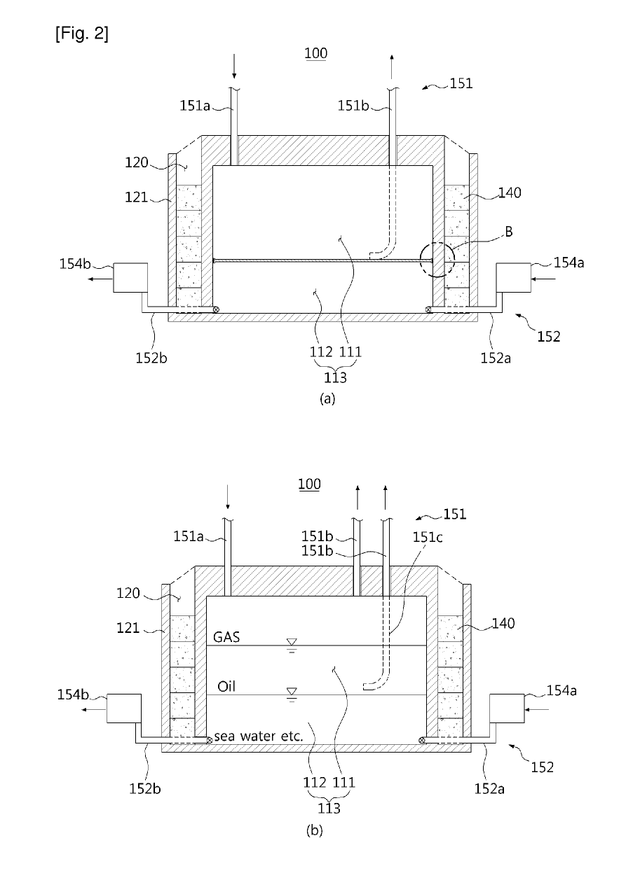

FIG. 1 is a side sectional view schematically illustrating a subsea storage tank according to an exemplary embodiment of the present invention. FIG. 2 is a side sectional view schematically illustrating pipe systems according to an exemplary embodiment of the present invention where the incoming fluid is mainly a liquid phase in FIG. 2(a) and a multi-phase in FIG. 2(b). FIG. 3 is a sectional view taken long line II-II of FIG. 1.

Referring to FIGS. 1, 2(a) and 3, the subsea storage tank 100 according to the exemplary embodiment of the present invention may include a body 100, one or more ballast chambers 120, and a separation unit 130.

The body 100 will have a storage space 113 therein. Hydrocarbon may be stored in the first space 111 and seawater may flow in and out of the second space 112; the size of second space 112 depends on how much hydrocarbons are stored in the first space 111. The hydrocarbon may be stored in the form of liquid, gas or a mixture where a liquid and a gas are mixed. This means that the first space 111 of the total storage space 113 is filled with the hydrocarbon, and the remaining second space 112 is filled with the seawater. Details thereof will be described below.

In this case, the hydrocarbon may include such as natural gas, oil, liquid petroleum gas (LPG) and natural gas liquids (NGL). And if so desired, other fluids can be stored in the storage space 113; for example, nitrogen at sea temperature in liquid state due to seafloor water pressure, and liquid carbon dioxide. Below is explained, for the convenience, the way the storage may be used for hydrocarbon applications.

The body 110 may be formed in the form of a cylinder or a polyprism. In the present exemplary embodiment, a case where the body 110 is formed in the form of a cylinder is shown in FIG. 3.

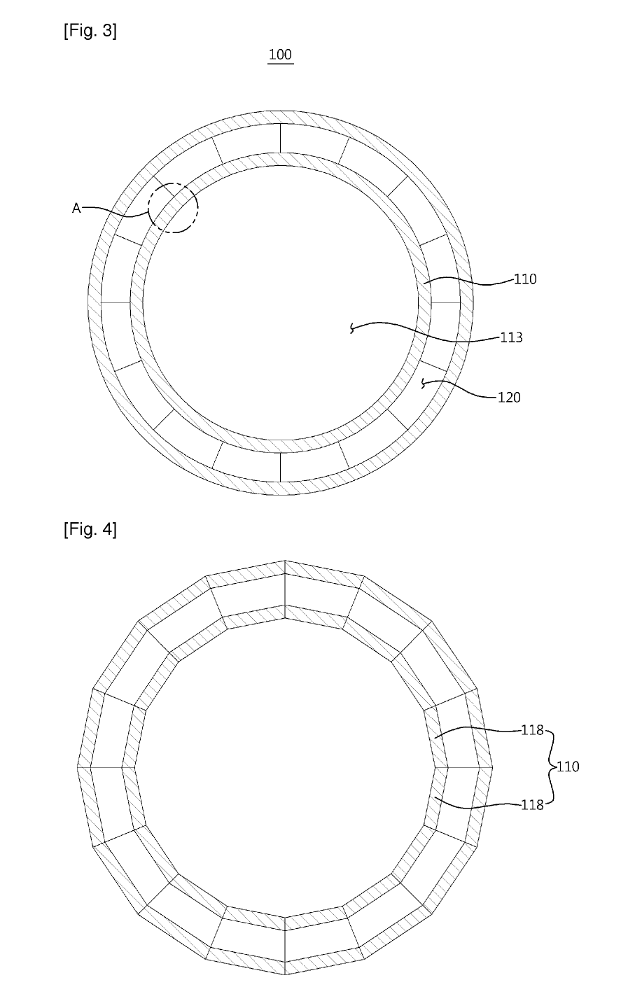

Meanwhile, FIG. 4 is a sectional view illustrating a variant example of the subsea storage tank of FIG. 1. Referring to FIG. 4, the body 110 may be formed in the form of a polyprism, that is a prismatic form with polyhedral cross-section. However, the outer shape of the body 110 may be modified in various forms if necessary, and is not limited the form of the exemplified cylinder or polyprism.

In addition, the body 110 may be separated into a plurality of body units if necessary, and may be assembled with plurality of body units. Referring to FIG. 4, the body 110 may be constituted of a plurality of body units 118 along a circumferential direction. In this case, the plurality of separated body units 118 may be assembled to form one body 110. However, a body with such shape may equally well be built as one construction unit.

Meanwhile, the body 110 may be formed of light weight concrete. In this case, inner and outer sides of the light weight concrete may be watertight coated or surface plated. Alternatively, the concrete may be cast within a double shell made of structural steel such that the steel-concrete composite structure becomes what normally is referred to as a sandwich structure. In this case, the steel both works as formwork for casting of the concrete as well as reinforcement and, equally important, as a watertight barrier between the concrete and the surroundings. There may be special connectors such as dowels, stiffeners and rails welded onto the steel plate surfaces that are in direct contact with the light weight concrete; the purpose of this is to ensure good structural integration between steel and concrete for all loading conditions. Further, at least one of a ceiling surface, a bottom surface, and a side surface of the body 110 may be formed with an outer wall formed of light weight concrete inner and outer sides of which are watertight coated or surface plated.

As will be understood later the purpose of using concrete with very light weight is to reduce the overall weight of the subsea storage tank 100 in the installation and submergence operation. The light weight concrete to be used herein will have density lighter than water whereas steel and other construction and processing materials will have density higher than that of water.

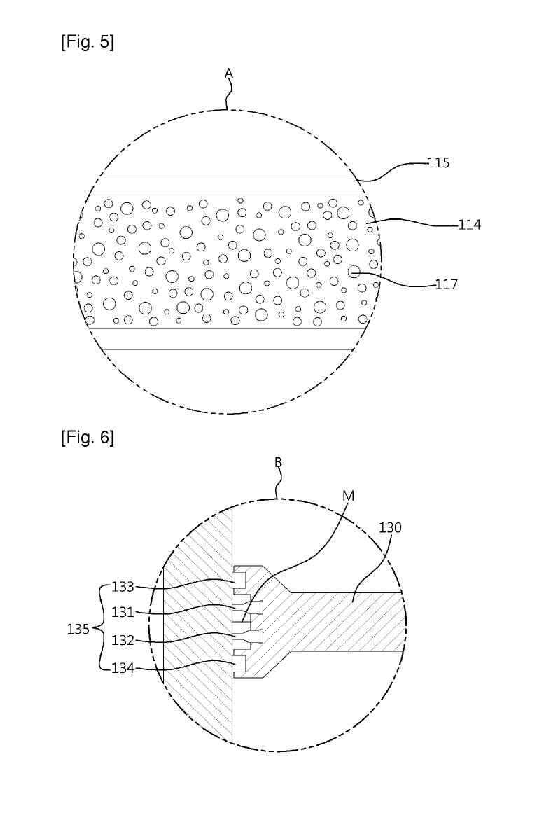

FIG. 5 is an enlarged view illustrating portion A of FIG. 3.

Referring to FIG. 5, inner and outer sides of light weight concrete 114 is surrounded by a watertight coating or plating 115. This is because the light weight concrete 114 is vulnerable to seawater exposure or the like can be protected from intrusion of seawater or the like. That is, the watertight surface layers 115 prevent seawater, oil or the like from penetrating into the voids of light weight concrete 114. Moreover, by using steel plates the strength and stiffness of the composite steel-concrete walls will be greatly enhanced as compared with concrete alone.

The use of the light weight concrete 114 can greatly reduce the weight of the subsea storage tank 100. Thus, the use of very light weight concrete 114, such as concrete with density similar to water or lighter, allows for a large scale size of the subsea storage tank 100. Further, the use of the light weight concrete 114 allows an easy installation of the subsea storage tank 100. Due to reduction in the weight of the subsea storage tank 100, the subsea storage tank 100 can be installed by using a crane vessel even when the subsea storage tank 100 has a very large scale.

As explained, the density of the light weight concrete 114 may be lower than the density of seawater. The light weight concrete 114 may be formed with a porous structure having porous aggregates and/or gas pores 117 therein. There are essentially three main approaches to attaining concretes with very low density: one is to apply a gas forming agent within a concrete mix, a second approach is to add air by way of chemicals and mechanical mixing, and a third approach is to make use of aggregates with very low density such as expanded burnt clay or glass. The above light weight concrete 114 is well known in the related art, a detailed description thereof will be omitted.

The watertight surface layers 115 may include steel surface plating. In the present exemplary embodiment, it is suggested that steel plates 115 are used as form work for the lightweight concrete 114 and thereby also become integrated structural elements as in sandwich design. The bonding between the steel plates 115 and the light weight concrete 114 may be chemical and frictional bonding as well as by use of structural bonding elements such as dowels or anchored stiffeners. Alternatively, the steel plate 115 may be bonded to an outer surface of the light weight concrete 114 through use of cement grout. The body 110 may be formed by an outer shape thereof of the light weight concrete 114 with surface steel plate cladding 115 on the outer surface of the light weight concrete 114. Further, the body 110 may be formed by an outer shape thereof with the steel plates 115 and pouring or injecting the light weight concrete 114 between the steel plates 115.

The steel used in the steel plates 115 may be corrosion or seawater resistant steel. And the surfaces of the steel plates 115 exposed to sea water may be coated with corrosion resistant paint, zinc or the like. Electrochemical protection may also be applied.

The watertight surface layers 115 may also include a polymer coating. That is, inner and outer sides of the light weight concrete 114 may be coated with a polymer. Then, the coated polymer may include epoxy.

Referring back to FIGS. 1, 2 and 3, the subsea storage tank 100 according to the present exemplary embodiment may include the ballast chamber 120.

The ballast chamber 120 will be applied after the towing and placement of the subsea storage tank 100 at the sea floor. The purpose of the ballast chamber 120 is to ensure that the subsea storage tank 100 will not depart from the sea floor (float up) after the subsea storage tank 100 is filled with hydrocarbons which have lower density than sea water. The ballast chamber 120 may be placed on the body 110 or in open chambers made for ballasting. The ballast chamber 120 may be filled with sand, gravel or one or several premade weight bodies 140 made of a heavy solid such concrete with heavy aggregates. The weight bodies 140 will be described below.

The ballast chamber 120 may be formed in open chambers along an outer peripheral surface of the body 110. In the present exemplary embodiment, it has been exemplified that the body 110 is formed in the form of a sectioned cylinder, and the ballast chamber 120 may be formed in the form of a sectioned circular ring along an outer peripheral surface of the body 110.

The ballast chamber 120 may be formed such that an upper end there of is open. Thus, after installation of the subsea storage tank 110 on the sea floor, the weight bodies 140 for anchoring the subsea storage tank 100 is installed in the ballast chamber 120 through the opened upper end of the ballast chamber 120. Further, when the subsea storage tank 100 lowers to the sea floor, seawater will be introduced into the ballast chamber 120.

Meanwhile, the subsea storage tank 100 according to the present exemplary embodiment may include a movable separation unit 130.

The separation unit 130 may be disposed in the storage space 113 formed within the body 110. The purpose of the separation unit 130 is to partition the storage space 113 into an upper and a lower side. That is, the storage space 113 may be partitioned into the first space 111 placed on the upper side and the second space 112 placed on the lower side by the separation unit 130. Hydrocarbons in the form of oil and/or gas may be stored in the first space 111. Seawater may be filled in the second space 112. This configuration will be described below.

The separation unit 130 may be formed to be moved upward and downward within the storage space 113. In this case, the separation unit 130 may be naturally moved upward and downward according to a water level of the seawater filled in the second space 112, this water level is in turn dependent on how much hydrocarbons are filled into the first space 111. That is, a mechanical driving force need not be applied to the separation unit 130 separately. Such performance may be achieved by designing the separation unit 130 with an average density which is lower than that of seawater, but higher than that of the hydrocarbons. In this way the separation unit 130 is floating on the seawater below, but sinking in relation to the lighter hydrocarbons. It may also be possible to apply mechanical forces for moving the separation unit 130; however, this may not be necessary provided the separation unit 130 is appropriately designed.

The separation unit 130 prevents the hydrocarbons stored in the first space 111 and the seawater filled in the second space 112 from being mixed. To this end, the separation unit 130 may be formed with a soft watertight membrane. Further, the separation unit 130 may be formed with a watertight plate. In the present exemplary embodiment, it is exemplified that the separation unit 130 is formed of the watertight plate 130. The purpose of this plate is to prevent hydrocarbons to mix with seawater. In this context it is interesting to note that the system would work appropriately even if the sealing along the sides should not be fully watertight; the reason for this is that hydrocarbons in the seawater would naturally seek to float upwards; thus, they would end up in the first space 111.

In this case of a naturally buoyant separation unit 130 between the first space 111 and the second space 112 the position and motion of the separation unit will be automatically controlled by the amount of hydrocarbons filled into the first space 111. Correspondingly, the amount of seawater in the second space 113 is determined by the remaining space and the fact that seawater will be allowed to flow in and out through an opening to the outer seawater at the lower end of the storage space 113.

Meanwhile, when the separation unit 130 is formed with the watertight plate 130, a sealing part 135 may be formed at the periphery of the watertight plate 130. As mentioned, it may not be critical that the sealing is fully watertight since hydrocarbons in the water will tend to move upwards in to the storage space 113. In any case, the sealing part 135 may serve the purpose of scraping off hydrocarbon deposits on the inner side of the storage space 113 and to provide a soft contact between the plate 130 and the tank walls 110.

FIG. 6 is an enlarged view illustrating portion B of FIG. 2.

Referring to FIG. 6, the sealing part 135 may include a pair of rubber seals 131 and 132 and a pair of sliding pads 133 and 134. The pair of rubber seals 131 and 132 is disposed vertically with a border surface of the hydrocarbon and the seawater being interposed there between. The pair of rubber seals 131 and 132 is attached to an inner wall surface of the storage space 113. The pair of sliding pads 133 and 134 may be disposed vertically with the pair of rubber seals 131 and 132 being interposed there between. The pair of sliding pads 133 and 134 is attached to an inner wall surface of the storage space 113. It is important that the total friction force developed in the seals and the pads remain smaller than the net buoyancy force of the watertight plate 130 in order that the watertight plate 130 should not get stuck. This particularly concerns the motion upwards whereas the motion downwards also is more directly controlled by the pressure in the hydrocarbons.

Meanwhile, the subsea storage tank 100 according to the present exemplary embodiment may play the role of the storage system and the gravitational separator without the movable separation unit 130 when the incoming fluid is a multi-phase, usually consisting of gas, oil, produced water, and mud. (Referring to FIG. 2(b))

Two interfaces develop: one between gas and oil, and the other between oil and the produced water. The position of these two interfaces changes in accordance with the volumetric flow rate of the incoming fluid and the outgoing streams. When the incoming fluid is greater than the outgoing stream, the two interfaces are lowered down and the produced water should be withdrawn from the subsea tank 100. In an opposite case, the two interfaces are going up and the sea water should enter the subsea tank 100 to replace the emptied space. In consequence, the seawater is naturally mixed with the produced water.

Referring back to FIGS. 1, 2 and 3, the subsea storage tank 100 according to the present exemplary embodiment may include the weight body 140 which may consist of many separate part units.

The weight body 140 has the purpose of securing that the subsea storage tank 100 remains at the sea floor after it is filled with hydrocarbons that are lighter than water, and may be installed in the ballast chamber 120. The weight body 140 may be installed in the ballast chamber along the periphery of the body as well as on the roof of the body 110.

The weight body 140 may include a concrete body, a concrete block, a sandbag, loose sand, gravel or rock, and the like. In the present exemplary embodiment, it is exemplified in that a concrete blocks are used as the weight body 140. However, the weight body 140 may be any other type of body that can anchor the subsea storage tank 100 to the sea floor with a predetermined submerged weight, and is not limited to the exemplified ones.

Meanwhile, although not illustrated, the subsea storage tank 100 according to the present exemplary embodiment may further include at least one or more of a friction pile, a suction pile, and a skirt wall as an additional or alternative anchoring unit. The friction pile, the suction pile, and the skirt wall may be attached to the subsea storage tank to anchor the subsea storage tank 100 to the sea floor together with the weight body 140 and submerged weight of the subsea storage tank 100 itself.

Referring to FIG. 2, the subsea storage tank 100 according to the present exemplary embodiment may further include a pipe system 151 and 152.

The pipe system 151 includes an inflow piping 151a that controls the inflow of hydrocarbons into the subsea storage tank 100. Moreover, the first pipe system 151 includes an outflow piping 151b that controls the outflow of hydrocarbons from the subsea storage tank 100.

The first pipe system 151 will normally be placed at the top of the subsea storage tank 100. Alternatively, the outflow piping 151b may include an internal flexible pipe 151c that is attached to the movable separation unit 130 such that it is made sure that the heaviest hydrocarbons are taken out first from the storage space 111 and do not accumulate there.

Further, there is a connection in the form of a pipe or an opening at the lower part of the subsea storage tank 100. This opening ensures that the second space 112 retains the same water pressure as the water at the outside of the subsea storage tank 100 by way of free inflow and outflow of sea water.

The second pipe system 152 includes an inflow piping 152a that controls the inflow of seawater into the lower space 112. Moreover, the second pipe system 152 includes an outflow piping 152b that controls the outflow of such as seawater, mud, produced water from the lower space 112.

The second pipe system 152 can be placed at the side of the subsea storage tank 100. Further, the inflow piping 152a and the outflow piping 152b can be equipped with cleansing system 154a and 154b to remove any deposits, impurities and hydrocarbons that follow the in- and outflow of seawater. The cleansing system for inflow of sea water 154a may include a filter unit to reject particulate materials and a chemical injection against marine biological growth within the subsea tank and the reservoir caused by the injected produced water. The cleansing system for outflow of the mixture of the sea water and the produced water with mud 154b may include a filter unit to separate the mud and water from each other. The separated water phase is usually injected back to the reservoir to boosting the well pressure.

Meanwhile, the subsea storage tank 100 according to the present exemplary embodiment may be formed to have an entire dry weight heavier than a weight of seawater corresponding thereto. This is because the subsea storage tank 100 can be lowered to the sea floor due to the self-weight of the subsea storage tank 100 when the subsea tank 100 is completely submerged in the seawater. At the same time the dry weight of the tank structure 100 should not be very much larger than the weight of the displaced sea water since the lowering of the tank 100 should not require exceedingly strong cranes or other types of lowering mechanisms for this operation.

Moreover, the subsea storage tank 100 according to the present exemplary embodiment may be formed to be floated on the seawater due to buoyant forces of the storage space 113 and the ballast chamber 120. Thus, the subsea storage tank 100 is floated on the seawater when seawater is not filled in the storage space 113 and/or the ballast chamber 120. Further, the subsea storage tank 100 may be floated on the seawater when seawater is partially filled in the storage space 113 and/or the ballast chamber 120. The purpose of ballasting with sea water during transportation may be to achieve better stability and to reduce exposure to wind by increasing the draft (submerged part). Thus, the subsea storage tank 100 may be transported to an installation location while being floated on the seawater.

Hereinafter, a method for installing a subsea storage tank according to an exemplary embodiment of the present invention will be described with reference to the accompanying drawings.

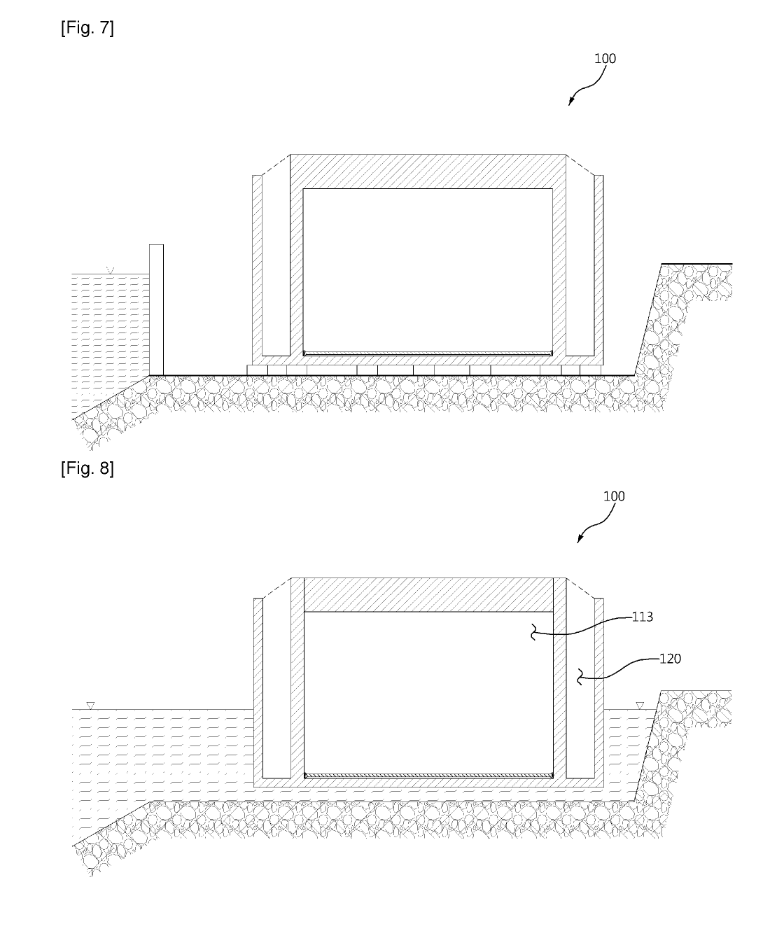

For the sake of convenience, it is noted that only main parts of the subsea storage tank illustrated in FIGS. 1 to 6 are illustrated in FIGS. 7 to 14.

FIG. 7 shows an operational view illustrating a method for construction of a subsea storage tank in a dock according to an exemplary embodiment of the present invention.

In the constructing step, the subsea storage tank 100 is being built. The composition of the subsea storage tank 100 is described with reference to FIGS. 1 to 6.

In this case, the constructing step may be performed in a dry dock. That is, the subsea storage tank 100 may be constructed within a dry dock space next to sea water. The subsea storage tank 100 according to the present exemplary embodiment may be completely constructed and equipped in a dry dock to be moved to and installed at a predetermined installation location. By completing as much construction and equipment as possible in the dry dock the amount of expensive offshore work can be minimized. Further, since the subsea storage tank 100 is constructed in a dry dock, the subsea storage tank 100 can be easily constructed and advantage can be taken of easy access for materials, workers and required equipment on land.

However, the construction step may be performed at the sea, if necessary. For example, the constructing step may be performed in an offshore floating dock, and is not limited to a dry dock. Alternatively, construction work of the lower part of the subsea storage tank 100 may take place in a dry dock whereas the completion of the upper parts of the subsea storage tank 100 may take place in floating condition at sea. One reason for such two-stage construction strategy may be that the dry dock itself and/or the coastal water next to the dry dock may be too shallow for floating out the total tank.

FIG. 8 is an operational view illustrating a launching method for installing a subsea storage tank according to the exemplary embodiment of the present invention.

In the launching step, the constructed subsea storage tank 100 is floated onto the seawater. In more detail, if the subsea storage tank 100 is constructed through the constructing step, a dock wall is opened and the seawater flows into the dock. In this case, the subsea storage tank 100 is floated on the seawater due to a buoyancy force of the storage space 113 and/or the ballast chamber 120.

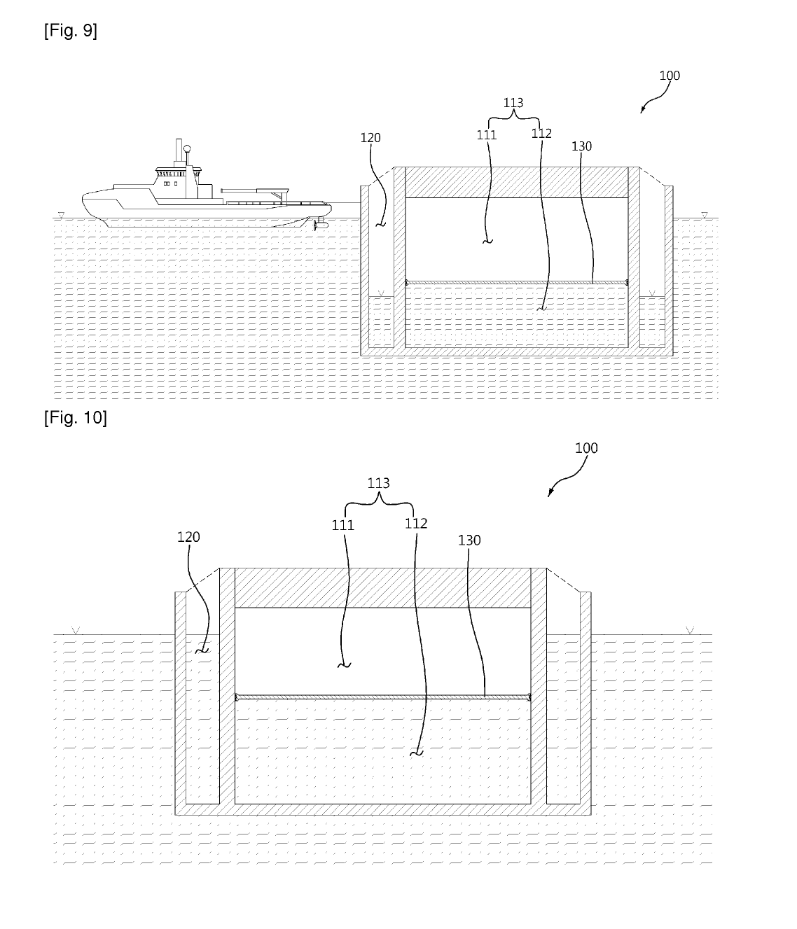

FIG. 9 shows an operational view of towing the tank to the intended location as part of the method for installing a subsea storage tank according to the exemplary embodiment of the present invention.

In the towing step, an operation for moving the subsea storage tank 100 to an installation location is performed. The towing step may be performed by one or several tug boat and possibly assisted by a crane vessel.

The towing step may be performed while the subsea storage tank 100 is floated on the seawater. In this case, the towing step may be performed in a state in which the seawater is filled into the subsea storage tank 100 to some degree. That is, the towing step may be performed in a state in which a predetermined amount of seawater is introduced into the storage space 113 or the ballast chamber 120, such that the draft of the subsea storage tank 100 is increased. In this way, the sufficient stability of the subsea storage tank 100 can be maintained during the tugging operation.

Meanwhile, as a predetermined amount of seawater is introduced into the storage space 113, the separation unit 130 within the storage space 113 is raised by the filling of the ballast water because the density of the separation unit 130 is lower than a density of the seawater and thereby will float on top.

FIG. 10 illustrates the operation of ballasting during installation of a subsea storage tank according to the exemplary embodiment of the invention.

In the ballast step, seawater is filled in a controlled way into the lower part of subsea storage tank 100 while floating in the seawater. In more detail, if the subsea storage tank 100 is moved to an installation location, the seawater is filled in the storage space 113 and the ballast chamber 120. As water levels of the storage space 113 and the ballast chamber 120 are raised, the subsea storage tank 100 is gradually lowered deeper into the sea.

Meanwhile, as a water level in the storage space 113 is raised, the separation unit 130 is gradually raised, and when seawater completely fills in the storage space 113, the separation unit 130 will raised to a ceiling surface of the storage space 113.

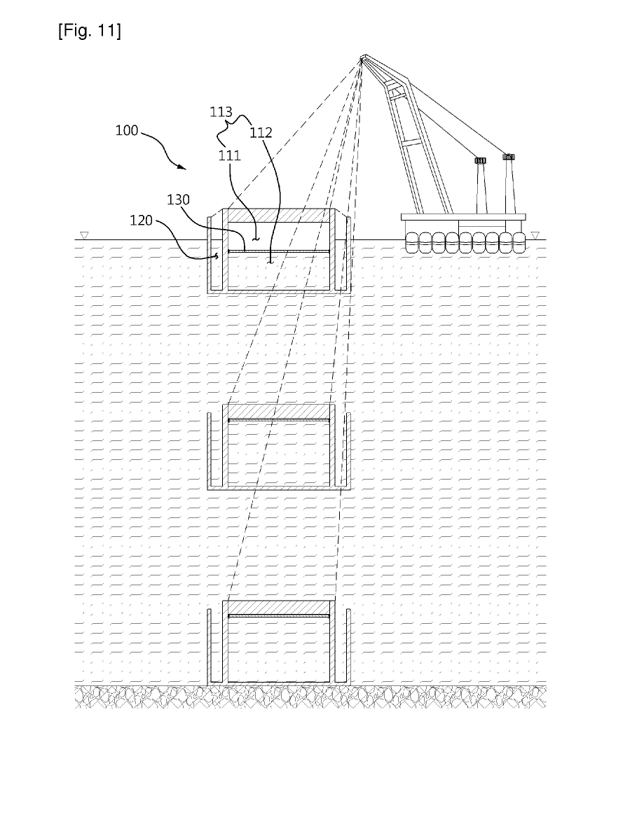

FIG. 11 shows different stages during the operation of lowering the subsea storage tank from the sea surface down to the sea floor according to the exemplary embodiment of the present invention.

In the placing step, the subsea storage tank 100 is lowered to be placed on the sea floor.

In this case, the lowering step may be performed in a state for which seawater completely fills the subsea storage tank 100 and there is no air in the subsea storage tank 100. That is, the lowering step may be performed in a state in which seawater is completely filled in the storage space 113 and the ballast chamber 120. In this case, since the water pressures inside and outside of the subsea storage tank 100 are the same, an influence of the water pressures can be minimized when the subsea storage tank 100 is installed. Further, the subsea storage tank 110 can be installed even in a deep sea where water pressure may be higher than 100 atm. This is an important advantage of the current invention rather than having to depend on partial buoyancy by entrapped air which means that additional air will have to be pumped into the tank as the existing air gradually becomes compressed during the lowering operation. Controlling such an air pumping operation and dealing with highly compressed air is indeed extremely complicated and in fact very dangerous.

Meanwhile, the subsea storage tank 100 according to the present exemplary embodiment may be formed to have an entire dry weight heavier than a weight of seawater corresponding thereto. Thus, if the seawater is completely filled in the subsea storage tank 100, the subsea storage tank 100 is lowered to the sea floor due to its own self-weight. In this case, a crane vessel 10 may be used to assist a lowering operation of the subsea storage tank 100. When the subsea storage tank 100 is lowered, the crane vessel 10 can carry the required submerged weight of the subsea storage tank 100. Thus, the crane vessel 10 can be assisted so that the subsea storage tank 100 is lowered in a controlled way with desired vertical speed.

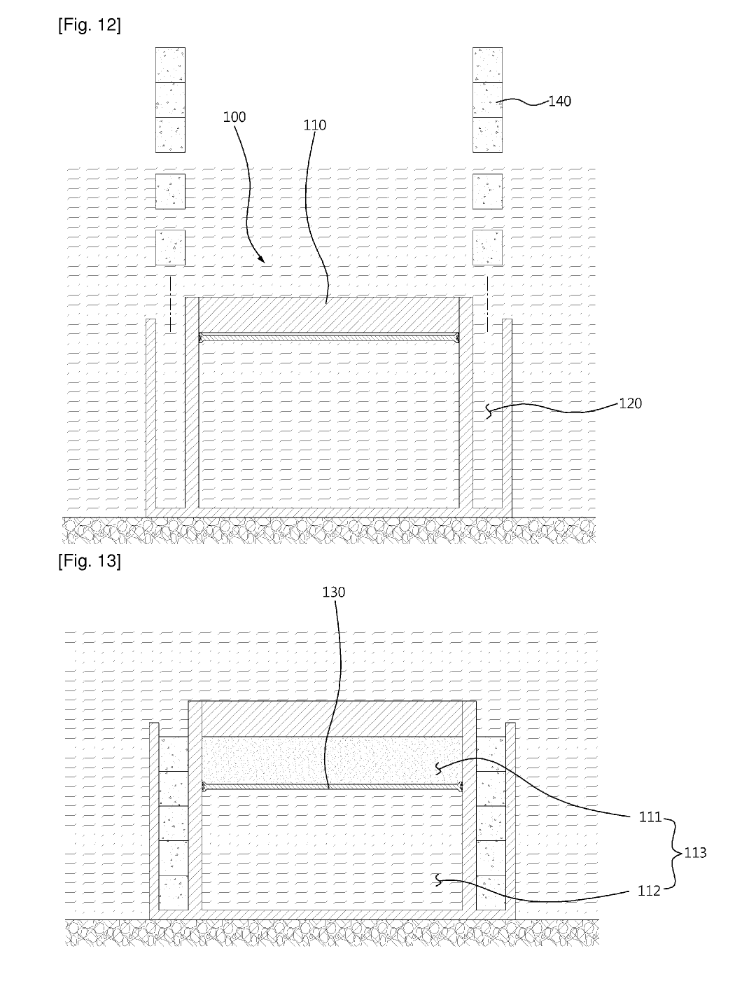

FIG. 12 shows an operational view of an anchoring step of the method for installing a subsea storage tank according to the exemplary embodiment of the present invention.

In the anchoring step, work for anchoring the subsea storage tank 100 to the sea floor is performed.

In this case, the subsea storage tank 100 may anchored to the sea floor using the weight body 140. The weight body 140 may be installed in the ballast chamber 120. The weight body 140 installed in the ballast chamber 120 anchors the subsea storage tank 100 to the sea floor by providing additional submerged weight. The weight body 140 may include a concrete body, a concrete block, a sandbag, loose sand, gravel and rocks and the like. In the present exemplary embodiment, it is exemplified that one or several concrete blocks 140 are used as the weight body 140. The weight body 140 may be installed in the ballast chamber 120 by using surface vessels with cranes, gravel dumping vessels or other ways of directing weight body 140 into correct position for the subsea storage tank 100.

Meanwhile, although not illustrated, the weight body 140 may be installed on top of the body 110 if so desired. For example, the weight body 140 may be installed on top of the body 110 to fix the subsea storage tank 100 due to the self-weight thereof. Although not illustrated, a friction pile, suction pile and skirt wall may be used to anchor the subsea storage tank 100, if necessary. The overall requirement for the sum of all ballasting and anchoring means is that the total anchoring force provided by these means should be sufficiently large so that subsea storage tank 100 will not float up when its storage space 113 is fully filled with hydrocarbons which are much lighter than water.

FIG. 13 shows an exemplary view of storage operation of the subsea storage tank after it has been securely installed and anchored to the sea floor.

It is to be noted that the separation unit 130 and the amount of seawater filling the second space 112 automatically adjust themselves in accordance with the amount of hydrocarbons that is filled into the total storage space.

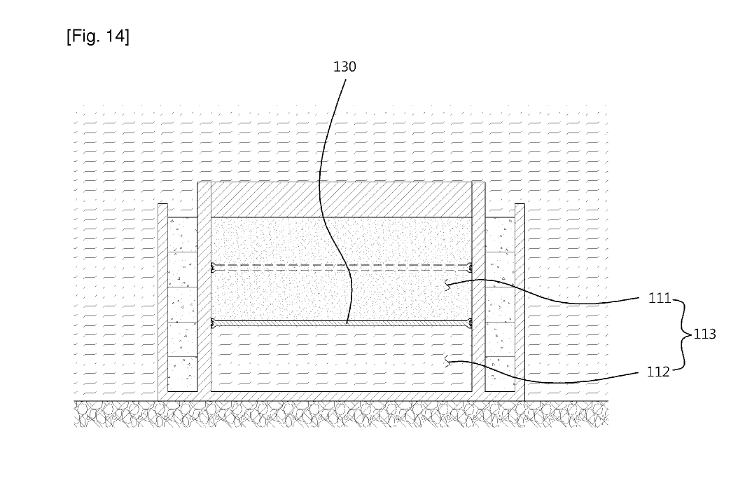

FIG. 14 shows another view where more hydrocarbons are filled or pumped into the storage tank.

In more detail, if the subsea storage tank 100 is anchored to the sea floor via the anchoring step, hydrocarbons in the form of oil and/or gas are to be stored in the storage space 113 of the subsea storage tank 100. In this case, since the storage space 113 is filled with seawater, the hydrocarbons in the form of oil and/or gas flows or is actively pumped into the storage space 113 through the first pipe system 151 connected with a first space 111. As the hydrocarbons in the form of oil and/or gas flow in, the first space 111 on the upper side of the storage space 113 is filled with hydrocarbon, and seawater is discharged from the storage space 113 through the second pipe system 152 or opening connected with a second space 112. As a result, as hydrocarbons in the form of oil and/or gas flow in or out of the first space 111 which thereby is filled with hydrocarbon, the second space 112 on the lower side is correspondingly filled with the seawater.

Meanwhile, as the hydrocarbons flow into the first space 111, the separation unit 130 is gradually lowered. Further, since a density of the separation unit 130 according to the present exemplary embodiment is lower than a density of seawater and higher than a density of hydrocarbon, the separation unit 130 will be disposed on the border surface between the hydrocarbon and the seawater while being floated on the seawater. Thus, the separation unit 130 is disposed between the hydrocarbon and the seawater without using a separate driving force to prevent the hydrocarbon and the seawater from being mixed.

Several other features, although not described herein, may be added to or included in the present invention. Examples of such are sensors and instrumentation that may be used to monitor the performance and condition of the tank itself as well as process systems associated with the tank. Auxiliary systems to perform removal of deposits in the tank are another example. Further, auxiliary systems for maintenance and repair as well as access devices and openings for carrying out such actions are other examples.

A further comment is that, as the tank is entirely filled with hydrocarbons being lighter than water, there will be a higher wall pressure on the inside of the tank than on the outside exposed directly to seawater. The reason for this is that there is pressure balance between the inside and the outside at the lower end of the tank where there is free flow of sea water between the inside and the outside. Because of lower density in the hydrocarbons the pressure decrease with increasing height will be less in the hydrocarbons on the inside than in the sweater on the outside. For this reason the tank will have to be designed for internal overpressure on the vertical tank wall as well as on the roof. This design requirement can easily be dealt with by steel surface plating as well as internal reinforcement in the lightweight concrete structure.

As will be understood a subsea tank that is intended for storing low density gas will have more severe design requirements than a tank intended for storing oil which has much higher density. The reason for this is that the differential pressure between external sea water and internal fluid will be much higher in the case with gas storage; the internal overpressure difference will be particularly severe at the upper part of the tank. Another design concern is the influence of water depth. The tank materials, such as steel and light weight concrete, will sustain the same hydrostatic pressure component as the water outside. Since light weight concrete has a much lower modulus of elasticity than that of steel the concrete will be volumetrically compressed more than the steel. This gives rise to different deformations of the materials which in turn may cause local stressing. As will be understood this problem becomes more severe with increasing water depth. However, this problem can be dealt with by careful design detailing and design considerations.

As described above, according to the subsea storage tank and the method for installing the subsea storage tank following the exemplary embodiments of the present invention, the subsea storage tank can be of very large scale and can be installed easily because of use of weight concrete with appropriate density. In the subsea storage tank and the method for installing the subsea storage tank according to the exemplary embodiments of the present invention, the subsea storage tank can be completely constructed on land, and can be moved to an installation location to be installed in the desired position. Accordingly, in the subsea storage tank and the method for installing the subsea storage tank according to the exemplary embodiments of the present invention, the subsea storage tank can be manufactured and installed with ease.

Moreover, in the subsea storage tank and the method for installing the subsea storage tank according to the exemplary embodiments of the present invention, the subsea storage tank can be installed and used in a state in which air is not present in the subsea storage tank, and thus can be installed and used in a very deep sea. In addition, according to the subsea storage tank and the method for installing the subsea storage tank according to the exemplary embodiment of the present invention, since the separation unit is installed within the subsea storage tank, the separation unit can naturally prevent seawater and hydrocarbons from being mixed.

Although the exemplary embodiments of the present invention have been described until now, it should be understood that those skilled in the art can variously change and modify the present invention through addition, modification, deletion, and addition of constituent elements without departing from the scope of the present invention described in the claims, and such changes and modifications fall within the scope of the present invention.

1. A subsea storage tank, comprising:
a body having a storage space therein and formed of light weight concrete inner and outer sides of which are watertight coated or layered;
a ballast chamber disposed at the body; and
a separation unit disposed inside the body and partitioning the storage space upper and lower, the separation unit being movable vertically in the storage space.

2. The subsea storage tank of claim 1, wherein the separation unit is being movable vertically in in accordance with the filling of the upper space.

3. The subsea storage tank of claim 1, wherein the body is formed in the form of a cylinder or a polyprism.

4. The subsea storage tank of claim 1, wherein the body is composed of a plurality of body units, the body is formed by assembling and joining the body units.

5. The subsea storage tank of claim 1, wherein a density of the light weight concrete is lower than the density of seawater.

6. The subsea storage tank of claim 1, wherein the watertight coating comprises at least one of steel plates, corrosion resistance steel plates, seawater resistant steel plates and polymer coating.

7. The subsea storage tank of claim 1, wherein the weight of the light weight concrete plus the coating and other structural parts is higher than the weight of the disposed seawater.

8. The subsea storage tank of claim 1, wherein the separation unit partitions the storage space into a first space at the upper portion and a second space at the lower portion, the first space containing stored fluids and the second space is formed such that seawater is allowed to flow freely in and out of the second space.

9. The subsea storage tank of claim 8, wherein the stored fluids include hydrocarbon fluids such as natural gas, oil, liquid petroleum gas (LPG) and natural gas liquids (NGL) as well as nitrogen at sea temperature in liquid state due to seafloor water pressure.

10. The subsea storage tank of claim 8, wherein the stored fluids are in any one state of a liquid state, a gas state and a mixed state of liquid and gas.

11. The subsea storage tank of claim 8, wherein a specific, average density of the separation unit is higher than the density of the heaviest components of the stored fluids and lower than the specific density of seawater such that the separation unit is naturally floating on top of the seawater in the chamber.

12. The subsea storage tank of claim 1, wherein the separation unit comprises at least one of a watertight membrane and a watertight plate, which are formed of a flexible material.

13. The subsea storage tank of claim 12, wherein a sealing part is formed at a border of the watertight plate, and comprises rubber seals being disposed upward and downward with the interface of the stored fluids and the seawater interposed there between; and a pair of sliding pads disposed upward and downward with a pair of the rubber sealing members interposed there between.

14. The subsea storage tank of claim 1, wherein the subsea storage tank is formed so as to be floated in the seawater by way of the buoyancy force of the storage space and/or the ballast chamber.

15. The subsea storage tank of claim 1, further comprising:
a first pipe system for controlled filling and emptying of stored fluids from the top of the storage space; and
a second pipe system or direct opening from the lower part of the storage space such that seawater can freely move in through one opening and out through another opening of the storage space in accordance with the degree of filling of stored fluids.

16. The subsea storage tank of claim 15, wherein the inflow of seawater to the storage space has to go through a separation unit to reject particulate and organic materials, and the outflow of seawater from the storage space has to go through a filter unit to reject the hydrocarbons mounted at the connecting pipe for inflow and outflow of seawater.

17. The subsea storage tank of claim 1, wherein the separation unit is omitted, and the interface between the oil and the water is controlled by the inflow of the sea water and by the outflow of the mixture of the produced water and seawater; in such way the tank may also serve the function of a gravitational separator.

18. The subsea storage tank of claim 17, wherein the inflow of seawater to the storage space has to go through a filter unit to reject particulate and organic materials and to have the option of chemical injection, and the outflow from the storage space has to go through a filter unit to reject the hydrocarbons and to discharge separately the mud flow and the mixture flow of the produced water and the seawater mounted at the connecting pipe for inflow and outflow.

19. The subsea storage tank of claim 1, further comprising:
a weight body installed on the ballast chamber or on the outside of the body in order to anchor and weigh down the subsea storage tank on the sea floor.

20. The subsea storage tank of claim 19, further comprising:
one or more friction piles, a suction piles and skirt walls as addition means of anchoring the subsea storage tank onto the sea floor.

21. A method for installing a subsea storage tank, comprising:
a construction step of construction a subsea storage tank;
a launching step of floating the subsea storage tank on the sea;
a towing step of moving the subsea storage tank to a selected installation location;
a ballast step of letting seawater into the subsea storage tank in a controlled manner to fully submerge the subsea storage tank;
a placing step of controlled lowering the subsea storage tank onto the sea floor; and
an anchoring step of anchoring the subsea storage tank on the sea floor.

22. The method of claim 21, wherein the towing step is performed in a state in which a predetermined amount of seawater is appropriately filled for ballasting into the subsea storage tank to float the subsea storage tank in a stable manner on the sea.

23. The method of claim 21, wherein the placing step is performed in a state in which the seawater is completely filled into the subsea storage tank and no air remains in the subsea storage tank.

24. The method of claim 21, wherein in the placing step, the subsea storage tank is lowered in a state in which the net weight of the submerged subsea storage tank is fully supported by a crane vessel on the sea.

25. The method of claim 21, wherein the anchoring step is performed by installing a weight body on a ballast chamber or on top of a body formed by the subsea storage tank.
